(19) United States
(12) Patent Application Publication
(10) Pub. No.: US 2024/0163757 A1
(43) Pub. Date: May 16, 2024

(54) ELECTRONIC DEVICE, COMMUNICATION METHOD AND STORAGE MEDIUM

(71) Applicant: Sony Group Corporation, Tokyo (JP)

(72) Inventors: Youping ZHAO, Beijing (CN); Yifei LIANG, Beijing (CN); Zhong TIAN, Beijing (CN); Chen SUN, Beijing (CN)

(73) Assignee: Sony Group Corporation, Tokyo (JP)

(21) Appl. No.: 18/549,169

(22) PCT Filed: Mar. 11, 2022
(86) PCT No.: PCT/CN2022/080284

§ 371 Date: Sep. 6, 2023

(30) Foreign Application Priority Data
Mar. 16, 2021 (CN) 202110279634.5

(51) Int. Cl. H04W 36/08; H04W 36/00; H04W 36/26

(52) U.S. Cl. CPC H04W 36/08; H04W 36/0061; H04W 36/00838; H04W 36/26

(57) ABSTRACT

The present disclosure relates to an electronic device, a communication method and a storage medium in a wireless communication system. There is provided an electronic device for a network control device, comprising a processing circuitry configured to: interact with one or more neighbor cells of a user equipment (UE) to acquire support information on network slice type suitable for the UE fed back by each of the neighbor cells; based on the support information, evaluate a service capability metric for each of the neighbor cells with respect to said network slice type; and at least based on the service capability metric, determine a selection priority of each of the neighbor cells for the UE.

### FIELD OF THE INVENTION

The present disclosure relates to wireless communication field, and more particularly, to an electronic device, a communication method, and a storage medium for cell selection or cell reselection.

### BACKGROUND

In recent years, vertical industries such as manufacturing industry, transportation, medical care and the like have explosively growing demands on mobile internet. These diverse vertical services have obvious differences in service requirement indexes such as network throughput, latency, reliability and the like, and it is difficult for traditional single network deployment pattern to meet the diversity of network service types and the differentiation of service requirements.

Network Slicing technique is introduced into 5G New Radio (NR) system. The network slicing technique is based on Network Function Virtualization (NFV), and allows a communication network to be divided into multiple network slices by implementing various virtual network functions over general devices, and an operator can allocate differentiated virtual network resources to different network slices, thereby satisfying different service requirements.

However, existing mechanisms have difficulty in providing efficient and rapid cell selection/reselection during serving users of a network slice. The main reason is that in existing cell selection/reselection mechanism, the cell selection behavior of a user is usually based on a selection order of cells in accordance with fixed priorities, and the user does not know whether the cells support the slice type of current service during the selection access process. It may occur that the cell to which the user chooses to access does not support the slice type desired by the user, resulting in a degradation of quality or even an interruption of the user's service, and a cell reselection has to be triggered again. This would cause an access latency and a reduced quality of service for the user of the network slice.

Therefore, there is a need to improve efficiency of the cell selection or reselection for a network slice user so as to achieve service continuity guarantee for critical users.

### SUMMARY OF THE INVENTION

The present disclosure provides aspects to meet the above need. The present disclosure comes up with a service guarantee mechanism for a network slice user based on network slice information of the user, so as to help the user to rapidly and efficiently access a cell that can provide a desired service to the user.

A brief summary regarding the present disclosure is given here to provide a basic understanding on some aspects of the present disclosure. However, it will be appreciated that the summary is not an exhaustive description of the present disclosure. It is not intended to identify key portions or important portions of the present disclosure, nor to limit the scope of the present disclosure. It aims at merely describing some concepts about the present disclosure in a simplified form and serves as a preorder of a more detailed description to be given later.

According to one aspect of the present disclosure, there is provided an electronic device for a network control device, comprising a processing circuitry configured to interact with one or more neighbor cells of a user equipment (UE) to acquire support information on network slice type suitable for the UE fed back by each of the neighbor cells; based on the support information, evaluate a service capability metric for each of the neighbor cells with respect to said network slice type; and at least based on the service capability metric, determine a selection priority of each of the neighbor cells for the UE.

According to one aspect of the present disclosure, there is provided an electronic device for a user equipment (UE), comprising a processing circuitry configured to receive information on selection priorities of one or more neighbor cells, wherein the selection priorities are determined by a network control device based on a service capability metric for each of the neighbor cells with respect to a network slice type suitable for the UE; and based on the selection priorities, select a neighbor cell to access.

According to one aspect of the present disclosure, there is provided an electronic device for a cell, comprising a processing circuitry configured to feed back support information on a particular network slice type to a network control device, for the network control device to determine a service capability metric for the cell with respect to the particular network slice type; receive RACH resource reservation information for the particular network slice type determined by the network control device based on the service capability metric; and reserve RACH resources determined for the particular network slice type based on the RACH resource reservation information.

According to one aspect of the present disclosure, there is provided a communication method, comprising: interacting with one or more neighbor cells of a user equipment (UE) to acquire support information on network slice type suitable for the UE fed back by each of the neighbor cells; based on the support information, evaluating a service capability metric for each of the neighbor cells with respect to said network slice type; and at least based on the service capability metric, determining a selection priority of each of the neighbor cells for the UE.

According to one aspect of the present disclosure, there is provided a non-transitory computer readable storage medium storing executable instructions which, when executed, perform the communication methods as described above.

### DESCRIPTION OF THE DRAWINGS

A better understanding of the present disclosure may be achieved by referring to a detailed description given hereinafter in connection with accompanying figures, wherein the same or similar reference signs are used to indicate the same or similar elements throughout the figures. The figures are included in the specification and form a part of the specification along with the following detailed descriptions, for further illustrating embodiments of the present disclosure and for explaining the theory and advantages of the present disclosure. Wherein,

FIG. 1 is a simplified diagram illustrating architecture of a 5G NR communication system;

FIG. 2 illustrates briefly a functional division of NG-RAN and 5GC in the NR communication system;

FIG. 3 illustrates a non-roaming reference architecture for the NR communication system in which various service-based interfaces used within a control plane are showed;

FIG. 4 schematically illustrates a scenario of cell reselection;

FIG. 5 illustrates three RRC states and transitions therebetween in the NR communication system;

FIG. 6 is a block diagram illustrating an electronic device according to a first embodiment;

FIG. 7 is a flowchart illustrating a communication method according to the first embodiment;

FIG. 8 illustrates an example of interaction according to the first embodiment;

FIG. 9 illustrates another example of interaction according to the first embodiment;

FIG. 10 illustrates an exemplary random access procedure;

FIG. 11 illustrates a block diagram of an electronic device according to a second embodiment;

FIG. 12 is a flowchart illustrating a communication method according to the second embodiment;

FIG. 13 is a signaling flow according to the second embodiment;

FIG. 14 is a schematic diagram illustrating a simulation scenario;

FIG. 15 is a graph of performance comparison as a result of the simulation;

FIG. 16 illustrates a first example of schematic configuration of the base station according to the present disclosure;

FIG. 17 illustrates a second example of schematic configuration of the base station according to the present disclosure;

FIG. 18 illustrates an example of schematic configuration of a smart phone according to the present disclosure; and

FIG. 19 illustrates an example of schematic configuration of an automobile navigation device according to the present disclosure.

Further features and aspects of the present disclosure will become apparent from the following description with reference to the attached drawings.

### DETAILED DESCRIPTION OF PREFERRED EMBODIMENTS

Various illustrative embodiments of the present disclosure will be described hereinafter with reference to the drawings. For purpose of clarity and simplicity, not all implementations of the embodiments are described in the specification. Note that, however, many settings specific to the implementations may be made in practicing the embodiments of the present disclosure according to specific requirements, so as to achieve specific goals of the developers. In addition, it should be understood that although the development work may be complex and laborious, such development work is only a routine task for those skilled in the art who benefit from the present disclosure

In addition, it should be understood that to avoid obscuring the present disclosure with unnecessary details, the figures illustrate only steps of a process and/or components of a device that are closely related to technical solutions of the present disclosure. The following description of exemplary embodiments is merely illustrative, and is not intended to be any limitation on the present disclosure and application thereof.

For convenient explanation of the technical solutions of the present disclosure, various aspects of the present disclosure will be described below in context of the 5G NR. However, it should be noted that this is not a limitation on the scope of application of the present disclosure. One or more aspects of the present disclosure can also be applied to various existing wireless communication systems, such as the 4G LTE/LTE-A, or various wireless communication systems to be developed in future. The architecture, entities, functions, processes and the like as described in the following description may find equivalents in the NR or other communication standards.

### Overview

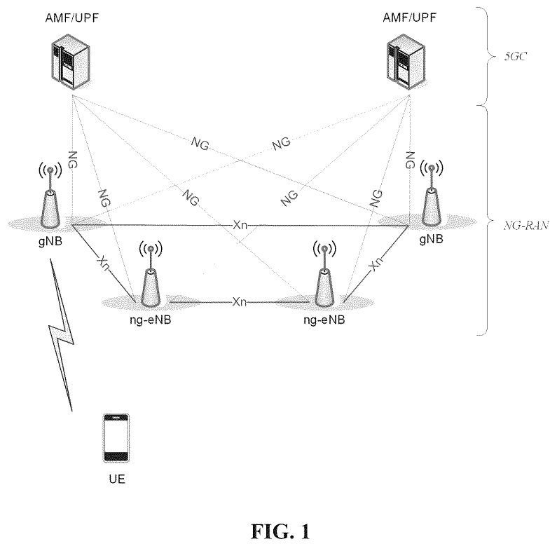

FIG. 1 is a simplified diagram showing an architecture of the 5G NR communication system. As shown in FIG. 1, on the network side, radio access network (NG-RAN) nodes of the NR communication system include gNBs and ng-eNBs, wherein the gNB is a newly defined node in the 5G NR communication standard, and provides NR user plane and control plane protocols terminating with a terminal equipment (also referred to as “user equipment”, hereinafter referred to as “UE”); the ng-eNB is a node defined to be compatible with the 4G LTE communication system, and it can be upgradation of evolved Node B (eNB) of the LTE radio access network, and provides user plane and control plane protocols for evolved universal terrestrial radio access (E-UTRA) terminating with the UE. Hereinafter. The gNB and ng-eNB are collectively referred to as “base station”.

However, it should be noted that the term “base station” used in the present disclosure is not limited to the above two types of nodes, but has the full breadth of its usual meaning. For example, in addition to the gNB and ng-eNB specified in the 5G communication standard, depending on scenarios in which the technical solution of the present disclosure is applied, the “base station” may also be, for example, an eNB in the LTE/LTE-A communication system, a remote radio head, a wireless access point, or a communication device that performs similar functions or elements thereof. Application examples of the base station will be described detailedly in the following chapter.

The coverage of a base station may be referred to as a “cell”. As used in the present disclosure, the cell includes various types of cells, for example, the cell may include a macro cell, a micro cell, a pico cell, a femto cell or the like, depending on the transmission power and coverage of the base station. The cell is typically identified by a cell ID (cell_id). Typically, there is one-to-one correspondence of a base station to a cell, but there may be another correspondence of a base station to a cell. Although behaviors of the cell described in the present disclosure is actually done by the base station, “cell” and “base station” are often used interchangeably for ease of understanding.

In addition, the term “UE” as used in the present disclosure has its full breadth of general meaning, including various terminal devices or vehicle-mounted devices that communicate with a base station. For example, the UE may be a terminal device such as a mobile phone, a laptop, a tablet, a vehicle communication device or the like. In the description of the present disclosure, “UE” and “user” are often used interchangeably. Application examples of the UE will be described detailedly in the following chapter.

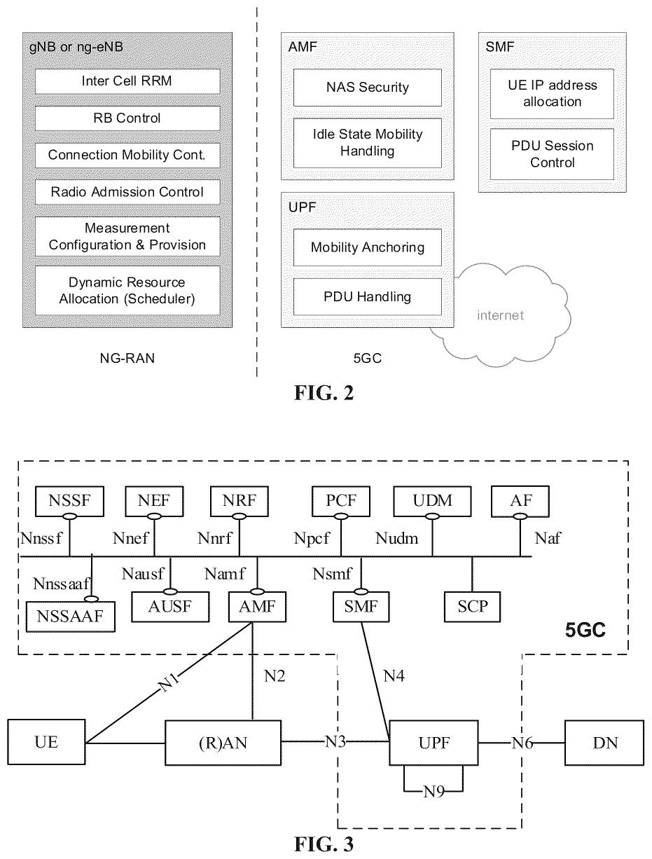

Through an air interface (an Uu interface), the UE may have radio access to a base station, such as a gNB or NG-eNB, which in turn is connected to a 5G core network (5GC) via an NG interface. The NG-RAN and the 5GC can carry out fronthaul and backhaul of data through a bearer network. They are respectively responsible for different functions at different levels and cooperate with each other to achieve network-side control of the wireless communication. FIG. 2 simply illustrates a functional division of the NG-RAN and the 5GC. As shown in FIG. 2, the gNB or ng-eNB may handle inter-cell Radio Resource Management (RRM), Radio Bearer (RB) control, radio admission control, connection mobility control, dynamic resource allocation of uplink and downlink, and the like.

The core network such as the 5GC is the brain of the wireless communication network and is responsible for managing and controlling the whole network. The 5GC adopts a micro-service architecture, namely, a service-based architecture, so as to realize “multiple network elements for single function”. The 5GC provides a number of network element devices, each providing respective network element function such as Access and Mobility Management Function (AMF), Session Management Function (SMF), User Plane Function (UPF), Policy Control Function (PCF), Network Slice Selection Function (NSSF), or the like. Among them, for example, the AMF may provide functions such as NAS security, idle state mobility management, access authentication and authorization and the like, and communicate with the UE via an N1 interface, and with the access network ((R)AN) via an N2 interface; the SMF can provide functions such as session management, UE IP address allocation and management, PDU session control and the like, and communicates with the UPF through an N4 interface; the UPF may provide mobility anchoring, PDU processing, packet routing and forwarding and the like, and communicates with the access network ((R)AN) via an N3 interface, and with a Data Network (DN) via an N6 interface.

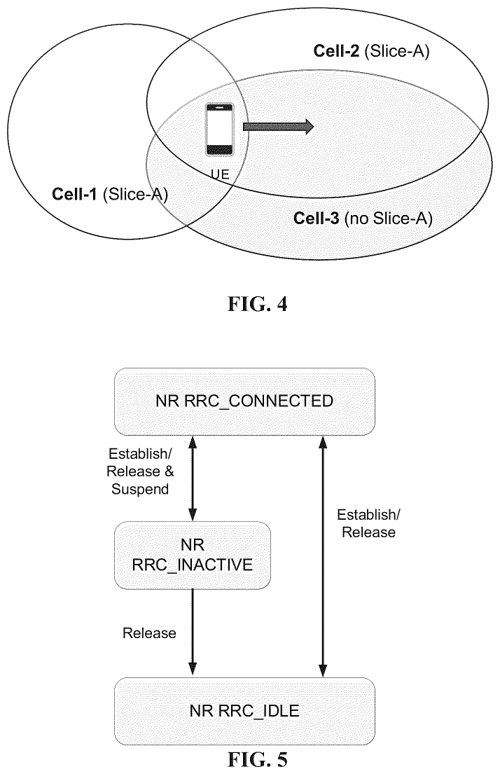

FIG. 3 illustrates a non-roaming reference architecture for the 5G NR system, in which a variety of service-based interfaces used within the control plane are shown. For example, as shown in FIG. 3, the AMF presents a Namf interface, the SMF presents an Nsmf interface, the PCF presents an Npcf interface, and so on. Each of the network functions, as a whole, may provide respective services outward via respective interfaces. For example, via the Namf interface, the AMF may provide services such as Namf_Communication (for enabling NF users to communicate with the UE or the access network through the AMF), Namf_EventExposure (for enabling NF users to subscribe to mobility-related events or statistics), Namf_MT (for enabling other NF users to confirm that the UE is reachable), Namf_Location (for enabling NF users to request location information of a target UE), and the like.

By providing various service-based interfaces, the network functions of the 5GC are virtualized, so that underlying hardware resources are decoupled from the network functions, and softwareization of the system functions and generalization of the hardware resources are realized. The virtualization of the network functions enables network slicing techniques. A “network slice” as referred to herein is a set of network functions (including core network functions and/or access network functions), and any other descriptor with the same function is equivalent in effect. Logically, each network slice represents a class of service requirements for a certain class of UE, and the network device selects corresponding network functions according to the service requirements of the UE to match with the service, so as to form a corresponding network slice. The most ideal way is that the network device dynamically combines functions of the core network device and/or of the access network device according to the service requirements of the UE, and then configures the functions to the UE. However, such a dynamic network configuration method is complex and very cumbersome to implement. Therefore, a simplified scheme is that the network device forms a plurality of network slices in advance in accordance with and to match intended UE types and service types, and when a UE needs to use the corresponding network slice, it sends its requirements to the network device, and then the network device configures the resources to the UE according to the corresponding network requirements.

Depending on an operational policy, an operational network slice operator of each network slice operator may provide a wide variety of network slice services. In the 5G system, services can be divided into three types: enhanced Mobile Broadband (eMBB) service characterized by a high bandwidth; massive Machine-type Communication (mMTC) service characterized by a high number of users; Ultra-Reliable and Low Latency Communication (URLLC) service characterized by high reliability and low latency. Therefore, the three types of services may be typically divided into three network slices, each of which may differ in charging policy, security policy, QoS (Quality of Service) policy and the like, and occurrence of a large-scale service congestion in one network slice does not affect the normal operation of services in other network slices. However, the actual network slice types may not be limited to these, and a slice operator may provide several, tens, or even hundreds of network slices to meet various service requirements.

With introduction of the network slice, the UE's access to a cell becomes more complex. FIG. 4 schematically illustrates a cell reselection scenario. As shown in FIG. 4, the UE is currently registered to the network and has received permitted Network Slice Selection Assistance Information (NSSAI), accesses a network slice Slice-A in current Cell 1, and maintains RRC-IDLE state. When the UE moves to an edge of Cell 1, the UE performs cell reselection evaluation and triggers cell reselection since the UE is at the edge of the cell. According to the current cell reselection mechanism, the UE may access to Cell 3 that does not support the current network slice type according to the cell selection priority list provided by the AMF, so that the slice service customized by the user is interrupted, and the cell reselection needs to be performed again until Cell 2 that supports Slice-A is selected. The inefficient cell selection (reselection) procedure may result in a reduction in quality of service, and degrade the user experience.

In view of this, the present disclosure contemplates taking network slice information into account in the cell selection/reselection so that a network slice user may quickly access a cell capable of providing a communication service that meets the Service Level Agreement (SLA) registered by him/her.

As used in the present disclosure, the terms “cell selection” and “cell reselection” are UE procedures described for different RRC states in a wireless communication standard. FIG. 5 illustrates three RRC states, namely, an RRC_IDLE state, an RRC_INACTIVE state, and an RRC_CONNECTED state, as well as transitions therebetween in the 5G NR system. Generally, after the UE is powered on, the UE is in the RRC_IDLE state, and may select a cell to camp on for the first time after PLMN or SNPN is selected, which is called “cell selection”, and then may enter the RRC_CONNECTED state by establishing an RRC connection. In addition, a UE in the RRC_CONNECTED state may enter the RRC_IDLE or RRC_INACTIVE state by releasing an RRC connection, and the UE that has transitioned to the RRC_IDLE or RRC_INACTIVE state may reselect a cell to camp on, which is called “cell reselection”. In contrast, a procedure in which the UE in the RRC_CONNECTED state accesses a target neighbor cell from the current serving cell is called “handover”.

In general, the cell selection includes both an initial cell selection and a cell selection with stored information. For the former, the UE has no priori knowledge of which RF channels are NR frequencies, and must scan all RF channels according to its capabilities to find a suitable cell. For the latter, the UE may pre-store information about the NR frequencies, and optionally cell parameters from previously received measurement control information elements or from previously detected cells, and use such information to find a suitable cell. Once the suitable cell is found, the UE selects that cell.

In addition, the UE measures signal quality and signal strength of the current serving cell and of neighbor cells according to a measurement criterion in the RRC_IDLE or RRC_INACTIVE state, and determines a cell to camp on according to a certain cell reselection criterion.

According to embodiments of the present disclosure, the core network may generate selection priority information of the neighbor cells based on network slice information of a UE to help the UE efficiently perform the cell selection/reselection. It should be noted, however, that while the present disclosure mainly discusses the cell selection/reselection scenarios, the cell priority information obtained according to the embodiments of the present disclosure may also be used in the handover scenario in the RRC CONNECTED state to facilitate an efficient cell handover procedure.

Exemplary embodiments of the present disclosure will be described in detail below.

### First Embodiment

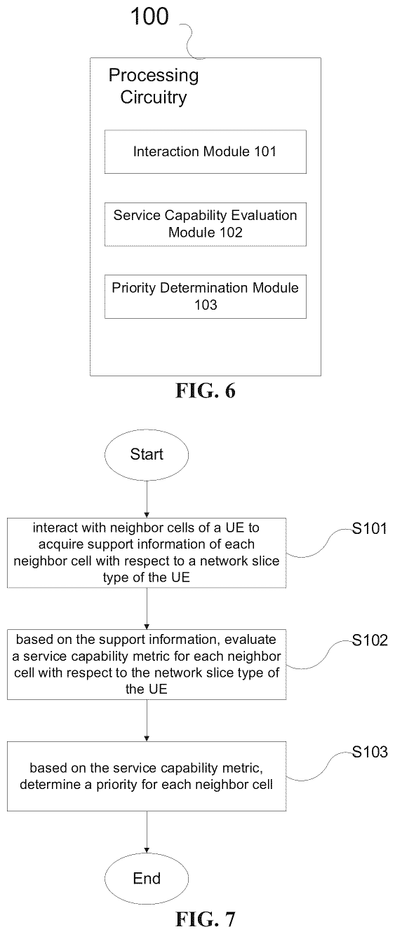

A first embodiment according to the present disclosure will be described with reference to FIGS. 6 and 7. FIG. 6 is a block diagram illustrating an electronic device 100 according to the first embodiment, and FIG. 7 illustrates a communication method that may be implemented by the electronic device 100 in FIG. 6.

The electronic device 100 comprises a processing circuitry that may be configured or programmed to perform various steps of the communication method shown in FIG. 7, thereby forming a plurality of modules that implement corresponding functionalities, such as an interaction module 101, a service capability evaluation module 102, a priority determination module 103.

The processing circuitry may refer to various implementations of digital, analog, or mixed-signal (a combination of analog signal and digital signal) circuitry for performing functions in a computing system. The processing circuitry may include, for example, circuitry such as an integrated circuit (IC), an application specific integrated circuit (ASIC), portions or circuits of an individual processor core, an entire processor core, a separate processor, a programmable hardware device such as a field programmable gate array (FPGA), and/or a system including multiple processors.

The electronic device 100 may be implemented as a network control device in a core network or a component therein. In the network function level, the interaction module 101, the service capability evaluation module 102, and the priority determination module 103 may be implemented in the AMF of the core network. Therefore, it can also be considered that the communication method according to the first embodiment is performed by the AMF.

The interaction module 101 of the electronic device 100 is configured to, for a certain network slice user (hereinafter referred to as “UE”), interact with one or more neighbor cells of the UE, i.e., to perform Step 5101 in FIG. 7. The interaction module 101 is intended to obtain, from each of the neighbor cells of the UE, various support information of the neighbor cell with respect to a network slice type required by the UE.

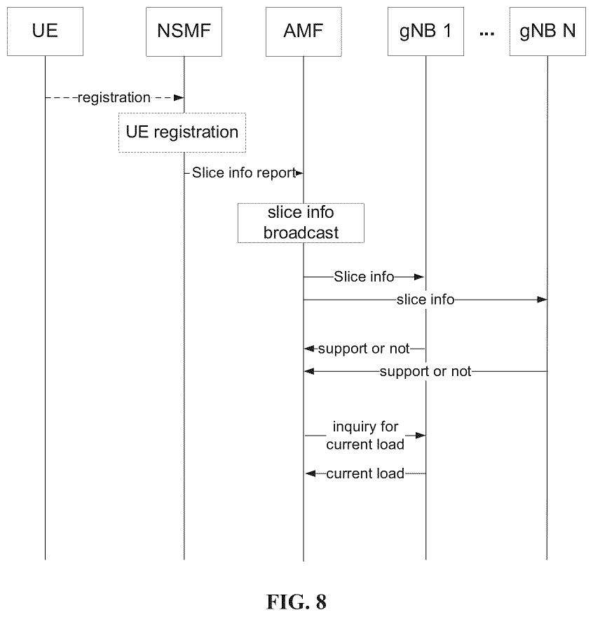

FIG. 8 illustrates an example of the interaction according to the first embodiment. As a preparatory work before the interaction of the interaction module 101 (AMF), the network slice information of the UE may be obtained from the NSSF. Generally, the UE may sign a contract with its network slice operator through an offline service hall, an online service hall, an APP or the like, determine required SLA parameters such as various indexes of transmission latency, transmission rate, service priority, security, reliability and the like, and initially register with a core network of the network slice operator. Based on the SLA parameters of the UE, the NSSF of the core network may select a network slice type suitable for the UE, e.g., an eMBB slice may be selected for the UE if it requires a high transmission rate, or a URLLC slice may be selected for the UE if it requires high reliability and low latency, although the actually selected slice type is not limited thereto. The NSSF may also select a set of network slice instances to serve the UE, determine permitted NSSAI, and determine a mapping to a subscribed S-NSSAI if needed. The NSSF may report information of the selected network slice for the UE to the AMF.

As shown in FIG. 8, the interaction module 101 broadcasts the network slice information of the UE to each of neighbor cells of the UE. Even if the UE is in the RRC_IDLE or RRC_INACTIVE state, the core network can still know a Tracking Area (TA) where the UE is located, thereby determining all neighbor cells of the UE, such as gNB 1, . . . , gNB N in FIG. 8. The neighbor cells gNB 1˜gNB N may include cells within a communication network of the slice operator with which the UE has signed a contract, or may include cells within a communication network of another slice operator that cooperates with the slice operator with which the UE has signed a contract. The interaction module 101 may send the network slice information of the UE to each of the neighbor cells, for example, via the N2 interface.

In one example, the interaction module 101 may send a network slice type (e.g., URLLC slice) as the slice information. This requires that the neighbor cells receiving the slice information agree on the network slice type with the interaction module 101, so that the neighbor cells can correctly identify the network slice type from the slice information.

In another example, the interaction module 101 may directly send the SLA parameters as the slice information for selecting a network slice for the UE, which is particularly useful when communication networks of different slice operators are involved, as different classifications on the network slices may be provided by different slice operators. For example, the slice operator with which the UE has signed a contract may select Network Slice A to serve the UE, while the slice operator of the neighbor cell gNB N does not provide Network Slice A, but Network Slice B which may meet the SLA parameters of the UE, and therefore, the neighbor cell gNB N receiving the slice information may determine that Network Slice B is a network slice type meeting the requirements of the UE according to the SLA parameters included in the slice information.

In response to receiving the slice information (e.g., the network slice type or SLA parameters), the neighbor cell determines whether it supports a network slice type suitable for the UE. If there is a network slice type suitable for the UE in the network slices that can be provided by the neighbor cell, a positive indication is fed back to the interaction module 101, whereas if the neighbor cell cannot provide the network slice type indicated in the slice information or cannot provide a network slice type meeting the SLA parameters included in the slice information, a negative indication is fed back to the interaction module 101.

Next, the interaction module 101 selects neighbor cells supporting a network slice type suitable for the UE, and performs interaction again to acquire further support information. Such support information may describe service capabilities of the neighbor cells with respect to that network slice type. In one example, how many UEs a neighbor cell can serve can be known through the interaction. As shown in FIG. 8, assuming that, as a result of the interaction of the first step, the neighbor cell gNB 1 supports the network slice type, and the neighbor cell gNB N does not support the network slice type, the interaction module 101 may inquire only those neighbor cells (e.g., gNB 1) with a support feedback about their current service load for the network slice type. The neighbor cells receiving the inquiry may feed back their current service load, such as the number of UEs of the network slice type currently being served, resource usage, etc., to the interworking module 101. In another example, quality of service of the neighbor cells for the network slice type may be learned through the interaction. For example, the interaction module 101 may inquire the neighbor cells for pass rate of service indexes for the network slice type, or the like. It should be understood that the content of the second interaction may not be limited thereto, and may additionally or alternatively include any support information for subsequently calculating the serving capability metrics of the neighbor cells with respect to the network slice type, such as an upper limit of the number of UEs for the network slice type, a QoS index, and so on.

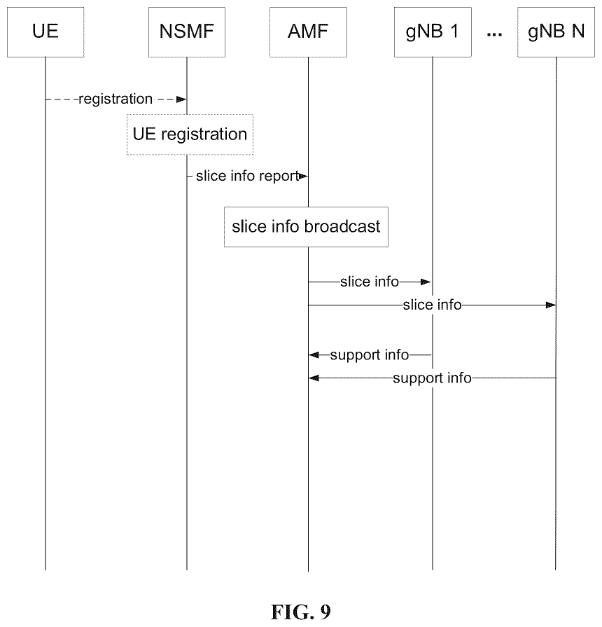

The interaction performed by the interaction module 101 may not use the two-step interaction process as shown in FIG. 8. FIG. 9 illustrates another example of the interaction according to the first embodiment. As shown in FIG. 9, the interaction module 101 (the AMF) broadcasts the network slice information of the UE, such as the network slice type or the SLA parameters, to all neighbor cells. In response to receiving the slice information, each of the neighbor cells feeds back support information regarding the network slice type suitable for the UE at one time, including but not limited to: whether the network slice type is supported or not, the current service load for the network slice type, and so on. Here, the form of the support information fed back by the neighbor cell is not limited. In one example, the support information may include a binary value indicating whether the network slice type is supported or not, a value of the current load, and the like; in another example, however, the support information may include only a value of the current load, and when the network slice type suitable for the UE is not supported, the neighbor cell may feed back the current load as 0, and otherwise may feed back the actual load value. The number of interactions shown in FIG. 9 is reduced compared to the interaction process in FIG. 8.

Returning to FIG. 6, the service capability evaluation module 102 of the electronic device 102 is configured to evaluate the service capability metric for each neighbor cell with respect to the network slice type suitable for the UE, based on the support information of each neighbor cell with respect to the network slice type acquired by the interaction module 101, that is, to perform Step S102 in FIG. 7. The service capability evaluation module 102 is intended to evaluate the service support capability of the neighbor cells for the associated network slice type, and perform a quantitative calculation, so as to provide a reference for the UE to determine which neighbor cell is the best choice.

As an exemplary factor to consider, the service capability evaluation module 102 may evaluate remaining accessible amount of each neighbor cell, since generally, the service load that the neighbor cell can still support is higher, the success rate of network slice user access is higher. For example, for each neighbor cell, the service capability metric of the neighbor cell with respect to the network slice type may be obtained by subtracting the number of currently served UEs (which is obtained from the neighbor cell by the interaction module 101) from an upper limit of the number of accessible UEs for the network slice type (which may be obtained from the policy control function PCF) to calculate the number of network slice users that the neighbor cell can still bear.

As another exemplary factor to consider, the service capability evaluation module 102 may evaluate a quality of service of each neighbor cell for the network slice type described above, since the quality of service provided by the neighbor cell is higher, the communication experience obtained by the network slice user is better. For example, for each neighbor cell, the service capability evaluation module 102 may obtain, as an index of the quality of service, an average of satisfactions (e.g., satisfaction scores given by UEs) of the neighbor cell currently serving all users of the network slice type from a slice management module (e.g., the NSSF) in the core network or through the interaction module 101, so as to obtain the service capability metric of the neighbor cell for the network slice type.

In addition to the above, there are other factors to consider. Preferably, all factors can be considered comprehensively, so as to fully characterize the service capability of each neighbor cell for the network slice type. For example, assuming that the slice meeting the SLA requirements of the UE is determined to be network slice type α, the service capability evaluation module 102 may calculate the service capability metric η_{α} of each neighbor cell using the following equation:

$${η}_{α} = tanh ( {S}_{{SLA}_{α}} \cdot ( 1 - \frac{{N}_{SLA \_α}}{{N}_{SLA \_α max}} ) ) \cdot {γ}_{α} \qquad ( 1 )$$

in the above equation, S_{SLA}_{_{α}} is an average satisfaction score for the network slice type α currently served by the neighbor cell, which is obtained by the slice management module (e.g., the NSSF) according to statistics fed back by the users in the cell, and takes a value between 0 and 1; N_{SLA_α} is a current service load (e.g., the number of currently served UEs) for the network slice type α, which is obtained from the neighbor cell by the interaction module 101 through the above interaction process; N_{SLA_αmax} is a predefined value of the upper limit of service load for the network slice type α, which is given by the PCF. The binary variable γ_{α} indicates that the network slice type is not supported in the configuration of the neighbor cell when γ_{α} is 0, and the network slice type is supported in the configuration of the neighbor cell when γ_{α} is 1.

Of course, the calculation of the service capability metric is not limited to the above equation (1), generally speaking, as long as the algorithm adopted by the service capability evaluation module 102 enables the value of the calculated service capability metric to be higher when the number of users that can be beared by the neighbor cell is higher or the quality of service is higher.

Based on at least the service capability metrics of the neighbor cells calculated by the service capability evaluation module 102, the priority determination module 103 may determine selection priorities of the neighbor cells, i.e., to perform Step S103 in FIG. 7. The selection priority of a neighbor cell may indicate an order in which the UE selects to access the neighbor cell when performing the cell selection/re selection.

In the simplest implementation, the priority determination module 103 may rank the neighbor cells by the values of the calculated service capability metric s to obtain a priority list of the neighbor cells. The resulting priority list may include only those neighbor cells supporting the network slice type of the UE, i.e., neighbor cells whose service capability metric is not zero, because the neighbor cells whose service capability metric is zero cannot provide the corresponding network slice service even if accessed.

In addition to the above implementation, the priority determination module 103 may optimize, i.e., re-rank, the priority list of existing neighbor cells based on the calculated values of the service capability metrics. For each of the neighbor cells, its service capability metric may be added to the calculation of its priority by a predetermined weight, so that the resulting priority list will reflect the supporting capability of the neighbor cell for the network slice type.

The selection priority information of the neighbor cells determined by the priority determination module 103 may be issued to the UE, for example, via the interface N1 in FIG. 3. If needed, the UE may select or reselect a cell based at least on the received selection priority information of the neighbor cells. The UE may first select a neighbor cell with the highest priority and perform an initial access procedure in order to attempt to access on a RACH frequency point of the neighbor cell.

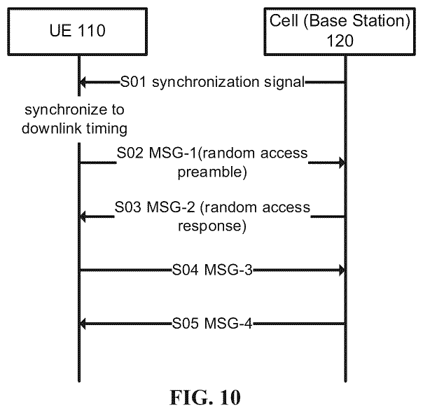

Exemplary initial access procedure operations are briefly described herein with reference to FIG. 10. At S02, UE 110 may inform Cell 120 of its access behavior by sending a random access preamble (e.g., included in MSG-1) to Cell 120. The transmission of the random access preamble enables Cell 120 to estimate uplink Timing Advance of the terminal device. At S03, Cell 120 may inform UE 110 of the timing advance by sending a random access response (e.g., included in MSG-2) to UE 110. UE 110 may achieve uplink cell synchronization with the timing advance. The random access response may also include information on uplink resources which may be used by UE 110 in the following operation 104. For a contention-based random access procedure, at S04, UE 110 may transmit an identity of the terminal device and optionally other information (e.g., included in MSG-3) over the scheduled uplink resources as described above. Cell 120 may determine a contention solution by the identity of the terminal equipment. At S05, Cell 120 may inform UE 110 of the contention solution (e.g., included in MSG-4). At this time, if the contention is successful, the UE 110 successfully accesses Cell 120, and the random access procedure ends; otherwise, the access fails.

If the access fails due to, for example, the neighbor cell having currently reached an access upper limit of the network slice type for the UE or occurrence of RACH resource congestion, the UE may select a neighbor cell having the second highest priority, and so on. Alternatively, the UE may also select or reselect a cell to access based on the selection priority of the neighbor cell as well as other factors, such as signal strength or signal quality of the neighbor cell. After the UE completes cell selection/reselection and camps on the neighbor cell, the UE may report the updated slice state information to the AMF through the NSSF.

Optionally, the selection priority information of the neighbor cells determined by the priority determination module 103 may be sent to the serving cell of the UE, for example, via the interface N2 in FIG. 3, for use in “handover” between cells. That is, in the RRC_CONNECTED state, when the UE moves to the edge of the serving cell, it may request handover to a neighbor cell, and if there are multiple neighbor cells available for selection at this time, the base station may determine a cell to be handed over to based on at least their selection priorities.

The electronic device 100 may be triggered to perform the communication method of FIG. 7 when predefined situations occur. One of the situations is that a wireless device information collecting and monitoring module in the serving cell of the UE is responsible for collecting UE-side data, such as a transmission rate and a transmission latency of the UE, the AMF determines whether the quality of service currently provided by the serving cell meets the SLA parameters registered by the UE based on the information collected by the serving cell, and if the quality of service provided by the serving cell does not meet the requirements, the AMF triggers performance of the communication method according to the present embodiment, and the electronic device 100 may start to interact with updated neighbor cells, determine selection priority information of the updated neighbor cells, and issue the selection priority information to the UE for the cell selection/reselection by the UE. Another situation is that the UE moves away from the current Tracking Area (TA) and enters another TA, and when the neighbor cell of the UE changes, the core network triggers performance of the communication method according to the present embodiment after monitoring that the TA of the UE changes. Alternatively, the electronic device 100 may also periodically perform the communication method according to the present embodiment, thereby dynamically updating the selection priority information of the neighbor cells.

By using the selection priority information determined according to the present embodiment, the UE can avoid the occurrence of access failure and service interruption due to the target cell not supporting a relevant network slice type, thereby improving the speed and success rate of the cell selection/reselection/handover, and ensuring that important network slice users obtain services in accordance with their requirements as registered.

### Second Embodiment

The UE may access the selected target cell in a contention-based manner. However, at present, there is no special access guarantee for network slice users of a critical service, and when a user, such as a URLLC slice user, performs the contention-based access with another slice type user (e.g., an eMBB user), it is difficult to provide a formal guarantee on quality of service for the user of the critical service due to access failure caused by RACH resource congestion that may occur. This is because the current RACH resources use a shared resource pool, and cannot implement differentiated cell access for users of different service types.

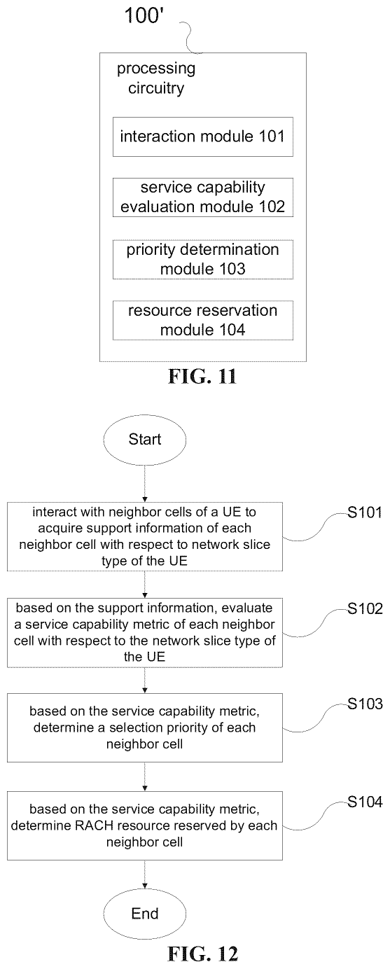

In view of this, the second embodiment of the present disclosure is directed to implementing wireless network resource isolation for users of different service types. FIG. 11 is a block diagram illustrating an electronic device 100′ according to the second embodiment, and FIG. 12 illustrates a communication method that may be implemented by the electronic device 100′ in FIG. 11. The following focuses on different aspects of the second embodiment from the first embodiment, and remaining aspects may refer to those described above in relation to the first embodiment.

The electronic device 100′ comprises a processing circuitry that may be configured or programmed to perform various steps of the communication method shown in FIG. 12, thereby forming a plurality of modules that implement corresponding functionality. The electronic device 100′ shown in FIG. 11 differs from the electronic device 100 in FIG. 6 in that it further comprises a resource reservation module 104. The resource reservation module 104 may also be implemented in the AMF.

The interaction module 101 and the service capability evaluation module 102 in the electronic device 100′ are the same as those in the electronic device 100, that is, the interaction module 101 acquires, by interacting with one or more neighbor cells of a UE, support information of each of the neighbor cells with respect to a network slice type suitable for the UE, and the service capability evaluation module 102 evaluates a service capability metric for each of the neighbor cells with respect to the network slice type based on the acquired support information, which will not be described in detail herein. According to the second embodiment, the resource reservation module 104 of the electronic device 100′ is configured to determine RACH resources to be reserved by a neighbor cell based on the service capability metric of the neighbor cell as calculated by the service capability evaluation module 102, i.e., to perform Step S104 in FIG. 12.

Generally, a network slice user wants to access a cell with strong service capability, but limited RACH resources may restrict the success rate of the contention-based access. Therefore, the resource reservation module 104 may formulate a RACH resource reservation scheme for the neighbor cell with respect to some important network slice types. For example, for the URLLC slice, the resource reservation module 104 may reserve some RACH resources in the neighbor cell for slice users to access, so as to avoid a situation that users of a critical service cannot obtain a quality of service guarantee due to common contention with eMBB slice users. Without limitation, the reservation scheme may be formulated for only some of the neighbor cells, such as those with a higher service capability metric than a predetermined threshold, because the selection priorities of these neighbor cells tend to be at the top, with a greater pressure for the contention-based access. For example, the resource reservation module 104 may determine the RACH resource reservation for only the first, two, three, or other number of neighbor cells with the highest service capability metrics. The RACH resources may be, for example, a portion of frequency points in the RACH resources allocated to the neighbor cell.

The resource reservation module 104 may be configured such that the larger the service capability metric of the neighbor cell is, the more RACH resources should be reserved. For example, idle RACH resources of the neighbor cell may be recycled. When the cell resource reservation is performed, a dynamic resource reservation scheme is preferably used to ensure flexibility and high efficiency of resource allocation of the system, so as to avoid excessive degradation in the quality of service for general users due to excessive resource reservation. An example of calculation of the resource reservation is given below.

After the service capability evaluation module 102 determines the service capability metric of each neighbor cell, for the neighbor cell selected to reserve the RACH resources, the resource reservation module 104 may calculate the resource reservation amount Nr_{α} of the cell according to the following equation:

Nr_{α}=tan h(N_{Σ})·η_{α}·λ (2)

in the above equation, N_{Σ} is the number of UEs that may select the network slice type α of the neighbor cell, which may be estimated by the number of slice information broadcasts for the network slice type received by the cell; η_{α} is is the service capability metric, e.g., calculated as equation (1) above; λ is a handover frequency parameter with a value between 0 and 1, and indicates how frequently a user performs switches in the cell, which is obtained from historical statistical data, the more frequently a user performs the switches in the cell, the closer to 1 the parameter is, otherwise, the parameter is closer to 0, so that the parameter can depict the mobility requirement and the switching frequency requirement of the user in the area, and the parameter is used for decrease a reduction in resource utilization caused by the resource reservation.

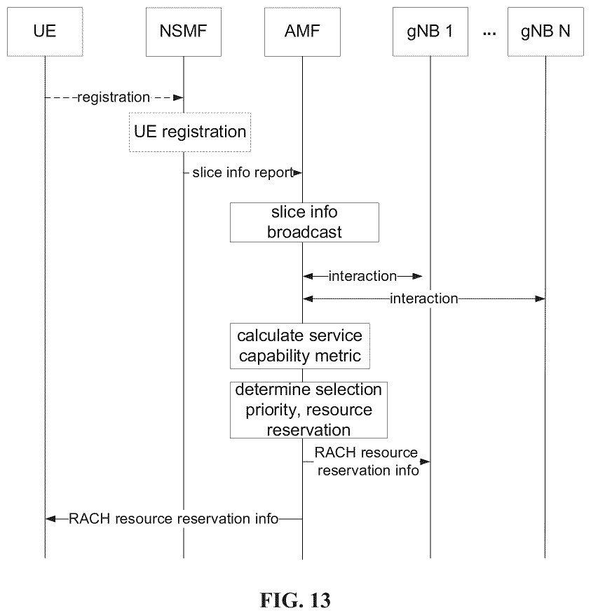

Based on the calculated resource reservation amount Nr_{α}, the resource reservation module 104 determines resources to be reserved, such as RACH frequency points corresponding to the reservation amount, among RACH resources (preferably, idle RACH resources) allocated to the neighbor cell. FIG. 13 illustrates an interaction flow diagram according to the second embodiment. As shown in FIG. 13, after determining the RACH resource reservation scheme for the neighbor cell, the electronic device 100′ may inform the neighbor cell of the corresponding resource reservation information, such as one or more RACH frequency points determined to be reserved, for example, via the N2 interface in FIG. 3. After receiving the RACH resource reservation information, the neighbor cell restricts the RACH resources to be accessed by only those UEs of the corresponding network slice type.

On the other hand, as shown in FIG. 13, the electronic device 100′ may inform the UE of the RACH resource reservation information of the neighbor cell, for example, via the N1 interface in FIG. 3. The RACH resource reservation information may be issued to the UE together with the selection priority information obtained by the priority determination module 103. After receiving the RACH resource reservation information, the UE may perform an initial access to the cell directly on the reserved RACH resource after choosing to access it.

It should be understood that although Step S104 of determining the reserved RACH resources is placed after Step S103 of determining the selection priority in FIG. 12, it is not necessary that they are performed in this order. For example, Step S104 may be performed before Step S103, or step S104 may be performed simultaneously with step S103.

Furthermore, according to the second embodiment, the priority determination module 103 of the electronic device 100′ may also determine the priority of each neighbor cell based on both the service capability metric obtained by the service capability evaluation module 102 and the RACH resource reservation scheme determined by the resource reservation module 104. For example, the priority determination module 103 may tend to give a higher priority to the neighbor cell with a higher service capability metric and a larger amount of RACH resource reservation.

According to the second embodiment of the present disclosure, the core network implements a resource isolation between the access by users of a particular network slice type and the access by general users in a resource reservation manner, thereby reducing or eliminating the contention pressure for the user of a critical service and improving the efficiency of cell access.

### Simulation

The technical solution of the present disclosure is verified below by simulation.

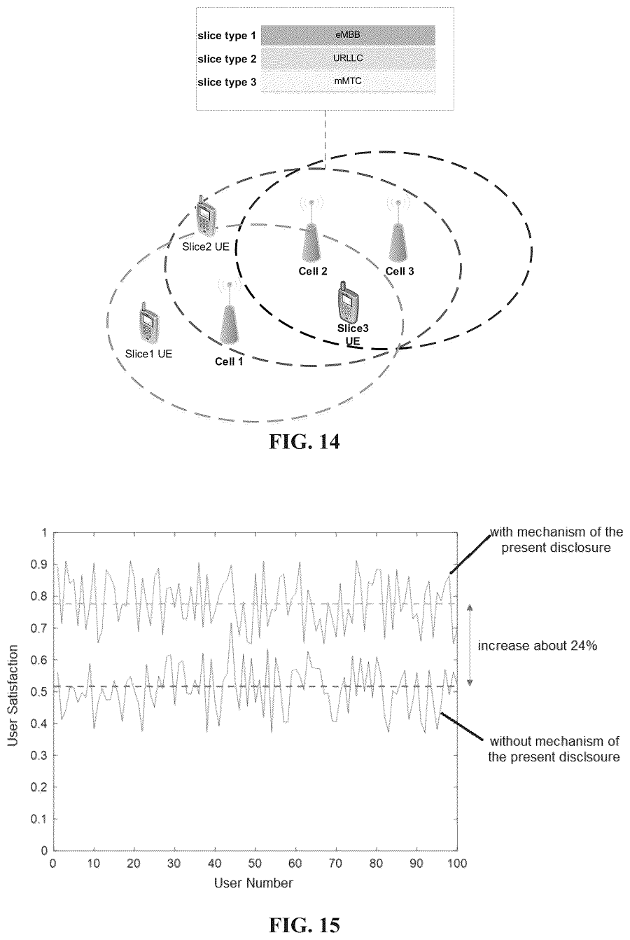

FIG. 14 is a schematic diagram of a simulation scenario set as a rectangular area of 1000 m×1000 m, where Cell 1, Cell 2, and Cell 3 provide an eMBB slice, a URLLC slice, and an mMTC slice, respectively. Other specific simulation parameters are shown in table 1:

TABLE 1
simulation parameter setting table

| Simulation parameters | Values of simulation parameters | |
|---|---|---|
| Simulation area | 1000 m × 1000 m | |
| Central frequency | 3.6 | GHz |
| Channel bandwidth | 1 | MHz |

| | |
|---|---|
| Pathloss coefficient | 3.2 |
| Number of base stations | 20 |
| Number of slice users | 100 |
| Types of slices | 3 |

FIG. 15 is a graph comparing the performance with the service guarantee mechanism for slice users in accordance with the second embodiment of the present disclosure and the performance without such mechanism. As indicated in the figure, two curves in the figure represent a service satisfaction of the users when using the mechanism of the present disclosure and when not using the mechanism, respectively. It can be seen that the service satisfaction of the users is improved by about 24% by using the solution.

It can be seen that, after the technical solution of the second embodiment is used, since the resource reservation is performed for network slice users having high SLA requirements, the switch success rate of the users in the switch procedures is obviously improved, and the service continuity is guaranteed.

Various aspects of the embodiments of the present disclosure have been described in detail above, but it should be noted that the structure, arrangement, type, number and the like of antenna arrays, ports, reference signals, communication devices, communication methods and the like are illustrated for purpose of description, and are not intended to limit the aspects of the present disclosure to these specific examples.

It should be understood that the various units of the electronic device 100 and 100′ described in the above embodiments are only logical modules divided according to specific functions they implement, and are not used to limit specific implementations. In an actual implementation, the foregoing units may be implemented as individual physical entities, or may also be implemented by a single entity (for example, a processor (CPU or DSP, etc.), an integrated circuit, etc.).

### Exemplary Implementations of the Present Disclosure

According to the embodiments of the present disclosure, various implementations for practicing concepts of the present disclosure can be conceived, including but not limited to:
1. An electronic device for a network control device, comprising a processing circuitry configured to: interact with one or more neighbor cells of a user equipment (UE) to acquire support information on a network slice type suitable for the UE fed back by each of the neighbor cells; based on the support information, evaluate a service capability metric for each of the neighbor cells with respect to said network slice type; and at least based on the service capability metric, determine a selection priority of each of the neighbor cells for the UE.
2. The electronic device according to 1, wherein the processing circuitry is further configured to: based on the evaluated service capability metric, determine RACH resources to be reserved by corresponding neighbor cell for said network slice type; and inform the corresponding neighbor cell and the UE of the determined RACH resource reservation information.
3. The electronic device according to 1 or 2, wherein the interacting comprises one of determining the network slice type suitable for the UE based on Service Level Agreement (SLA) parameters registered by the UE, and sending information on the network slice type to the one or more neighbor cells; or sending the SLA parameters registered by the UE to the one or more neighbor cells.
4. The electronic device according to 3, wherein the interacting comprises: receiving, from each of the one or more neighbor cells, support information on whether the neighbor cell supports said network slice type or not.
5. The electronic device according to 4, wherein the interacting further comprises: inquiring a neighbor cell which supports said network slice type about a current service load for said network slice type; and receiving, from the neighbor cell, support information on the current service load for said network slice type.
6. The electronic device according to 3, wherein the interacting comprises: receiving, from each of the one or more neighbor cells, support information on whether the neighbor cell supports said network slice type or not and on a current service load for said network slice type.
7. The electronic device according to 3, wherein the SLA parameters includes at least one of transmission latency, transmission rate, service priority, security, and reliability.
8. The electronic device according to 1, wherein said network slice type includes one of URLLC slice, eMBB slice, and mMTC slice.
9. The electronic device according to 1, wherein the processing circuitry is configured to initiate said interacting in occurrence of the following: the UE moving to another tracking area; quality of service of the network slice currently provided by a serving cell of the UE not meeting Service Level Agreement (SLA) parameters registered by the UE; or per predetermined time interval.
10. The electronic device according to 5 or 6, wherein the processing circuitry is configured to evaluate the service capability metric η_{α} for each of the neighbor cells with respect to said network slice type according to

$${η}_{α} = tanh ( {S}_{{SLA}_{α}} \cdot ( 1 - \frac{{N}_{SLA \_α}}{{N}_{SLA \_α max}} ) ) \cdot {γ}_{α}$$

where S_{SLA}_{_{α}} is an average satisfaction of service of the network slice type α currently provided by the neighbor cell, N_{SLA_α} is a current service load for the network slice type α of the neighbor cell, N_{SLA_αmax} is an upper limit of service load for the network slice type α of the neighbor cell, and γ_{α} is a binary variable indicating whether the neighbor cell supports the network slice type α or not.
11. The electronic device according to 2, wherein the processing circuitry is configured to determine an amount Nr_{α} of the RACH resources that should be reserved by a neighbor cell:

Nr_{α}=tan h(N_{Σ})·η_{α}·λ

where N_{Σ} is a number of UEs that might select the network slice type α of the neighbor cell, η_{α} is the service capability metric for the neighbor cell with respect to the network slice type α, and λ is a selection frequency parameter.
12. The electronic device according to 2, wherein the processing circuitry is configured to reserve the RACH resources for the network slice type in idle RACH resources of the neighbor cell.
13. The electronic device according to 1, wherein the processing circuitry is further configured to: send information on the selection priorities of the neighbor cells to the UE, so that the UE selects or reselects a cell to access based on the selection priorities.
14. The electronic device according to 1, wherein the processing circuitry is further configured to: send information on the selection priorities of the neighbor cells to a serving cell of the UE, so that the serving cell selects a target cell to be switched to based on the selection priorities.
15. An electronic device for a user equipment (UE), comprising a processing circuitry configured to: receive information on selection priorities of one or more neighbor cells, wherein the selection priorities are determined by a network control device based on a service capability metric for each of the neighbor cells with respect to a network slice type suitable for the UE; and based on the selection priorities, select a neighbor cell to access.
16. The electronic device according to 1, wherein the processing circuitry is further configured to: receive information on RACH resources to be reserved by a particular neighbor cell for the network slice type, the reserved RACH resources are determined by the network control device based on the service capability metric for the particular neighbor cell; and access the particular neighbor cell on the reserved RACH resources.
17. The electronic device according to 15, wherein said network slice type includes one of URLLC slice, eMBB slice, and mMTC slice.
18. An electronic device for a cell, comprising a processing circuitry configured to feed back support information on a particular network slice type to a network control device, for the network control device to determine a service capability metric for the cell with respect to the particular network slice type; receive RACH resource reservation information for the particular network slice type determined by the network control device based on the service capability metric; and reserve RACH resources determined for the particular network slice type based on the RACH resource reservation information.
19. A communication method, comprising: interacting with one or more neighbor cells of a user equipment (UE) to acquire support information on a network slice type suitable for the UE fed back by each of the neighbor cells; based on the support information, evaluating a service capability metric for each of the neighbor cells with respect to said network slice type; and at least based on the service capability metric, determining a selection priority of each of the neighbor cells for the UE.
20. A non-transitory computer readable storage medium storing executable instructions which, when executed, perform the communication method according to 19.

### Application Examples of the Present Disclosure

The technology described in the present disclosure can be applied to various products.

For example, the electronic devices 100 and 100′ according to the embodiments of the present disclosure may be implemented as various network control devices in the core network. The communication method according to the embodiments of the present disclosure can be implemented by various network functions in the core network. The UE according to the embodiments of the present disclosure may be implemented as various user equipment or in various user equipment. The base station according to the embodiments of the present disclosure can be implemented as various base stations or in various base stations.

The base station as described in the present disclosure may be implemented as any type of base station, preferably, such as the macro gNB or the small gNB in the NR (New Radio) access technology of the 3GPP 5G communication standar. A small gNB may be an gNB that covers a cell smaller than a macro cell, such as a pico gNB, micro gNB, and home (femto) gNB. Instead, the base station may be implemented as any other types of base stations such as a NodeB, eNodeB and a base transceiver station (BTS). The base station may include a main body configured to control wireless communication, and one or more remote radio heads (RRH), a wirelesss relay, a drone control tower or the like disposed in a different place from the main body.

The user equipment may be implemented as a mobile terminal such as a smartphone, a tablet personal computer (PC), a notebook PC, a portable game terminal, a portable/dongle type mobile router, and a digital camera apparatus, or an in-vehicle terminal such as a car navigation device. The user equipment may also be implemented as a terminal (that is also referred to as a machine type communication (MTC) terminal) that performs machine-to-machine (M2M) communication, a drone or the like. Furthermore, the user equipment may be a wireless communication module (such as an integrated circuit module including a single die) mounted on each of the above terminals.

### 1. Application Examples of the Base Station

It will be appreciated that as used in the present disclosure, the term “base station” has the full breadth in its generic sense, and includes at least a wireless communication station used as a portion of a wireless communication system or a radio system for purpose of communication. Examples of the base station can be for example but is not limited to the following: either or both of the base transceiver station (BTS) and the base station controller (BSC) in the GSM system; either or both of the radio network controller (RNC) or NodeB in the 3G communication system; eNB in the LTE and LTE-Advanced system; corresponding network nodes in future communication systems (for example, the gNB possibly appearing in the 5G communication system, or the like). In communication senarios such as D2D, M2M and V2V, a logical entity having a control function over the communication can be referred to a base station. In the scenario of cognitive radio communication, a logical entity having a function of frequency spectrum coordination can also be referred to a base station.

### First Application Example

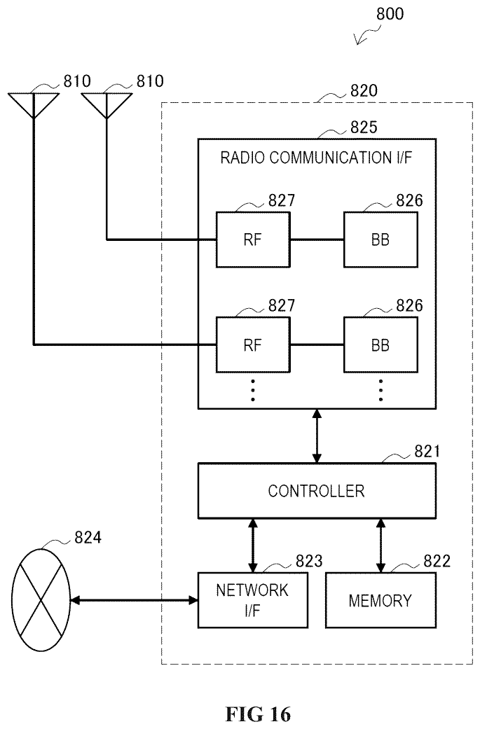

FIG. 16 is a block diagram illustrating a first example of a schematic configuration of the base station to which a technology of the present application may be applied. In FIG. 16, the base station is illustrated as an gNB 800. The gNB 800 includes a plurality of antennas 810 and a base station device 820. The base station device 820 and each antenna 810 may be connected with each other via a RF cable.

The antennas 810 may include one or more antenna arrays, the antenna array including multiple antenna elements (such as multiple antenna elements included in a Multiple Input and Multiple Output (MIMO) antennas), and is used for the base station 820 to transmit and receive radio signals. The gNB 800 may include multiple antennas 810, as illustrated in FIG. 16. For example, the multiple antennas 810 may be compatible with multiple frequency bands used by the gNB 800. FIG. 16 illustrates the example in which the gNB 800 includes multiple antennas 810.

The base station device 820 includes a controller 821, a memory 822, a network interface 823, and a radio communication interface 825.

The controller 821 may be, for example, a CPU or a DSP, and operates various functions of a higher layer of the base station device 820. For example, the controller 821 may include the processing circuitry 301 or 601 as described above, perform the communication method as described with reference to the above first to fourth embodiments, or control the components of the electronic device 500, 700, 1000, 1500, or 1600. For example, the controller 821 generates a data packet from data in signals processed by the radio communication interface 825, and transfers the generated packet via the network interface 823. The controller 821 may bundle data from multiple base band processors to generate the bundled packet, and transfer the generated bundled packet. The controller 821 may have logical functions of performing control such as radio resource control, radio bearer control, mobility management, admission control, and scheduling. The control may be performed in corporation with an gNB or a core network node in the vicinity. The memory 822 includes RAM and ROM, and stores a program that is executed by the controller 821, and various types of control data such as a terminal list, transmission power data, and scheduling data.

The network interface 823 is a communication interface for connecting the base station device 820 to a core network 824. The controller 821 may communicate with a core network node or another gNB via the network interface 823. In that case, the gNB 800, and the core network node or the other gNB may be connected to each other through a logical interface such as an S1 interface and an X2 interface. The network interface 823 may also be a wired communication interface or a radio communication interface for radio backhaul. If the network interface 823 is a radio communication interface, the network interface 823 may use a higher frequency band for radio communication than a frequency band used by the radio communication interface 825.

The radio communication interface 825 supports any cellular communication scheme such as Long Term Evolution (LTE), LTE-Advanced or NR, and provides radio connection to a terminal positioned in a cell of the gNB 800 via the antenna 810. The radio communication interface 825 may typically include, for example, a baseband (BB) processor 826 and an RF circuit 827. The BB processor 826 may perform, for example, encoding/decoding, modulating/demodulating, and multiplexing/demultiplexing, and performs various types of signal processing of layers such as L1, medium access control (MAC), radio link control (RLC), and a packet data convergence protocol (PDCP). The BB processor 826 may have a part or all of the above-described logical functions instead of the controller 821. The BB processor 826 may be a memory that stores a communication control program, or a module that includes a processor configured to execute the program and a related circuit. Updating the program may allow the functions of the BB processor 826 to be changed. The module may be a card or a blade that is inserted into a slot of the base station device 820. Alternatively, the module may also be a chip that is mounted on the card or the blade. Meanwhile, the RF circuit 827 may include, for example, a mixer, a filter, and an amplifier, and transmits and receives radio signals via the antenna 810.

The radio communication interface 825 may include the multiple BB processors 826, as illustrated in FIG. 16. For example, the multiple BB processors 826 may be compatible with multiple frequency bands used by the gNB 800. The radio communication interface 825 may include the multiple RF circuits 827, as illustrated in FIG. 16. For example, the multiple RF circuits 827 may be compatible with multiple antenna elements. Although FIG. 16 illustrates the example in which the radio communication interface 825 includes the multiple BB processors 826 and the multiple RF circuits 827, the radio communication interface 825 may also include a single BB processor 826 or a single RF circuit 827.

In the gNB 800 illustrated in FIG. 16, one or more of the units included in the processing circuitry may be implemented in the radio communication interface 825. Alternatively, at least a part of these components may be implemented in the controller 821. As an example, the gNB 800 includes a part (for example, the BB processor 826) or the entire of the radio communication interface 825 and/or a module including the controller 821, and the one or more components may be implemented in the module. In this case, the module may store a program (in other words, a program causing the processor to execute operations of the one or more components) causing the processor to function as the one or more components, and execute the program. As another example, a program causing the processor to function as the one or more components may be installed in the gNB 800, and the radio communication interface 825 (for example, the BB processor 826) and/or the controller 821 may execute the program. As described above, as a device including the one or more components, the gNB 800, the base station device 820 or the module may be provided. In addition, a readable medium in which the program is recorded may be provided.

### Second Application Example

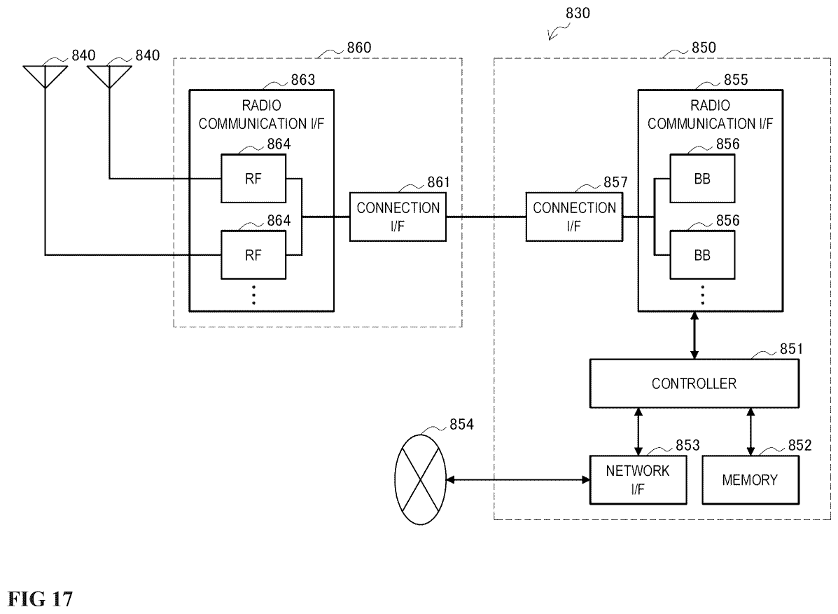

FIG. 17 is a block diagram illustrating a second example of a schematic configuration of the base station to which a technology of the present application may be applied. In FIG. 17, the base station is illustrated as gNB 830. The gNB 830 includes one or more antennas 840, a base station device 850, and an RRH 860. Each antenna 840 and the RRH 860 may be connected to each other via an RF cable. The base station device 850 and the RRH 860 may be connected to each other via a high speed line such as an optical fiber cable.

The antennas 840 includes one or more antenna arrays, the antenna array including multiple antenna elements such as multiple antenna elements included in an MIMO antenna and is used for the RRH 860 to transmit and receive radio signals. The gNB 830 may include multiple antennas 840, as illustrated in FIG.17. For example, multiple antennas 840 may be compatible with multiple frequency bands used by the gNB 830. FIG. 17 illustrates an example in which the gNB 830 includes multiple antennas 840.

The base station device 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 16.

The radio communication interface 855 supports any cellular communication scheme such as LTE, LTE-Advanced or NR, and provides radio communication to a terminal positioned in a sector corresponding to the RRH 860 via the RRH 860 and the antenna 840. The radio communication interface 855 may typically include, for example, a BB processor 856. The BB processor 856 is the same as the BB processor 826 described with reference to FIG. 16, except the BB processor 856 is connected to the RF circuit 864 of the RRH 860 via the connection interface 857. The radio communication interface 855 may include the multiple BB processors 856, as illustrated in FIG. 17. For example, multiple BB processors 856 may be compatible with multiple frequency bands used by the gNB 830. Although FIG. 17 illustrates the example in which the radio communication interface 855 includes multiple BB processors 856, the radio communication interface 855 may also include a single BB processor 856.

The connection interface 857 is an interface for connecting the base station device 850 (radio communication interface 855) to the RRH 860. The connection interface 857 may also be a communication module for communication in the above-described high speed line that connects the base station device 850 (radio communication interface 855) to the RRH 860.

The RRH 860 includes a connection interface 861 and a radio communication interface 863.

The connection interface 861 is an interface for connecting the RRH 860 (radio communication interface 863) to the base station device 850. The connection interface 861 may also be a communication module for communication in the above-described high speed line.

The radio communication interface 863 transmits and receives radio signals via the antenna 840. The radio communication interface 863 may typically include, for example, the RF circuit 864. The RF circuit 864 may include, for example, a mixer, a filter, and an amplifier, and transmits and receives radio signals via the antenna 840. The radio communication interface 863 may include multiple RF circuits 864, as illustrated in FIG. 17. For example, multiple RF circuits 864 may support multiple antenna elements. Although FIG. 17 illustrates the example in which the radio communication interface 863 includes the multiple RF circuits 864, the radio communication interface 863 may also include a single RF circuit 864.

In the gNB 830 illustrated in FIG. 17, one or more of the units included in the processing circuitry may be implemented in the radio communication interface 855. Alternatively, at least a part of these components may be implemented in the controller 851. As an example, the gNB 830 include a part (for example, the BB processor 856) or the entire of the radio communication interface 855 and/or a module including the controller 851, and the one or more components may be implemented in the module. In this case, the module may store a program (in other words, a program causing the processor to execute operations of the one or more components) causing the processor to function as the one or more components, and execute the program. As another example, a program causing the processor to function as the one or more components may be installed in the gNB 830, and the radio communication interface 855 (for example, the BB processor 856) and/or the controller 851 may execute the program. As described above, as a device including the one or more components, the gNB 830, the base station device 850 or the module may be provided. A program causing the processor to function as the one or more components may also be provided. In addition, a readable medium in which the program is recorded may be provided.

### 2. Application Example of the User Device

### First Application Example

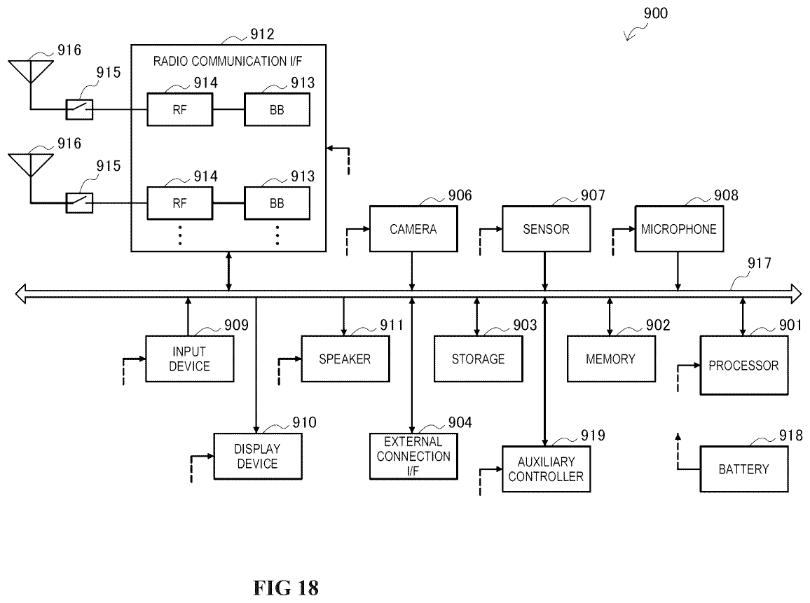

FIG. 18 is a block diagram illustrating an example of a schematic configuration of a smartphone 900 to which a technology of the present application may be applied. The smartphone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls functions of an application layer and the other layers of the smartphone 900. The processor 901 can include or serve as the processing circuitry 501, 701, 1001, 1501 or 1601 as described in the embodiments. The memory 902 includes RAM and ROM, and stores a program that is executed by the processor 901, and data. The storage 903 may include a storage medium such as a semiconductor memory and a hard disk. The external connection interface 904 is an interface for connecting an external device such as a memory card and a universal serial bus (USB) device to the smartphone 900.

The camera 906 includes an image sensor such as a charge coupled device (CCD) and a complementary metal oxide semiconductor (CMOS), and generates a captured image. The sensor 907 may include a group of sensors such as a measurement sensor, a gyro sensor, a geomagnetic sensor, and an acceleration sensor. The microphone 908 converts the sounds that are input to the smartphone 900 to audio signals. The input device 909 includes, for example, a touch sensor configured to detect touch onto a screen of the display device 910, a keypad, a keyboard, a button, or a switch, and receives an operation or an information input from a user. The display device 910 includes a screen such as a liquid crystal display (LCD) and an organic light-emitting diode (OLED) display, and displays an output image of the smartphone 900. The speaker 911 converts audio signals that are output from the smartphone 900 to sounds.

The radio communication interface 912 supports any cellular communication scheme such as LTE, LTE-Advanced or NR, and performs radio communication. The radio communication interface 912 may typically include, for example, a BB processor 913 and an RF circuit 914. The BB processor 913 may perform, for example, encoding/decoding, modulating/demodulating, and multiplexing/demultiplexing, and performs various types of signal processing for radio communication. Meanwhile, the RF circuit 914 may include, for example, a mixer, a filter, and an amplifier, and transmits and receives radio signals via the antenna 916. The radio communication interface 912 may also be a one chip module that integrates the BB processor 913 and the RF circuit 914 thereon. The radio communication interface 912 may include multiple BB processors 913 and multiple RF circuits 914, as illustrated in FIG. 18. Although FIG. 18 illustrates the example in which the radio communication interface 912 includes multiple BB processors 913 and multiple RF circuits 914, the radio communication interface 912 may also include a single BB processor 913 or a single RF circuit 914.

Furthermore, in addition to a cellular communication scheme, the radio communication interface 912 may support another type of radio communication scheme such as a short-distance wireless communication scheme, a near field communication scheme, and a wireless local area network (LAN) scheme. In that case, the radio communication interface 912 may include the BB processor 913 and the RF circuit 914 for each radio communication scheme.

Each of the antenna switches 915 switches connection destinations of the antennas 916 among multiple circuits (such as circuits for different radio communication schemes) included in the radio communication interface 912.

The antennas 916 may include multiple antenna elements such as multiple antenna elements included in an MIMO antenna, and is used for the radio communication interface 912 to transmit and receive radio signals. The smartphone 900 may include multiple antennas 916, as illustrated in FIG. 18. Although FIG. 18 illustrates the example in which the smartphone 900 includes multiple antennas 916, the smartphone 900 may also include a single antenna 916.

Furthermore, the smartphone 900 may include the antenna 916 for each radio communication scheme. In that case, the antenna switches 915 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to blocks of the smartphone 900 illustrated in FIG. 18 via feeder lines, which are partially shown as dashed lines in the figure. The auxiliary controller 919 operates a minimum necessary function of the smartphone 900, for example, in a sleep mode.

In the smartphone 900 illustrated in FIG. 18, one or more of the components included in the processing circuitry may be implemented in the radio communication interface 912. Alternatively, at least a part of these components may also be implemented in the processor 901 or the auxiliary controller 919. As an example, the smartphone 900 include a part (for example, the BB processor 913) or the entire of the radio communication interface 912, and/or a module including the processor 901 and/or the auxiliary controller 919, and the one or more components may be implemented in the module. In this case, the module may store a program (in other words, a program causing the processor to execute operations of the one or more components) causing the processor to function as the one or more components, and execute the program. As another example, a program causing the processor to function as the one or more components may be installed in the smartphone 900, and the radio communication interface 912 (for example, the BB processor 913), the processor 901 and/or the auxiliary controller 919 may execute the program. As described above, as a device including the one or more components, the smartphone 900 or the module may be provided. A program causing the processor to function as the one or more components may also be provided. In addition, a readable medium in which the program is recorded may be provided.

### Second Application Example

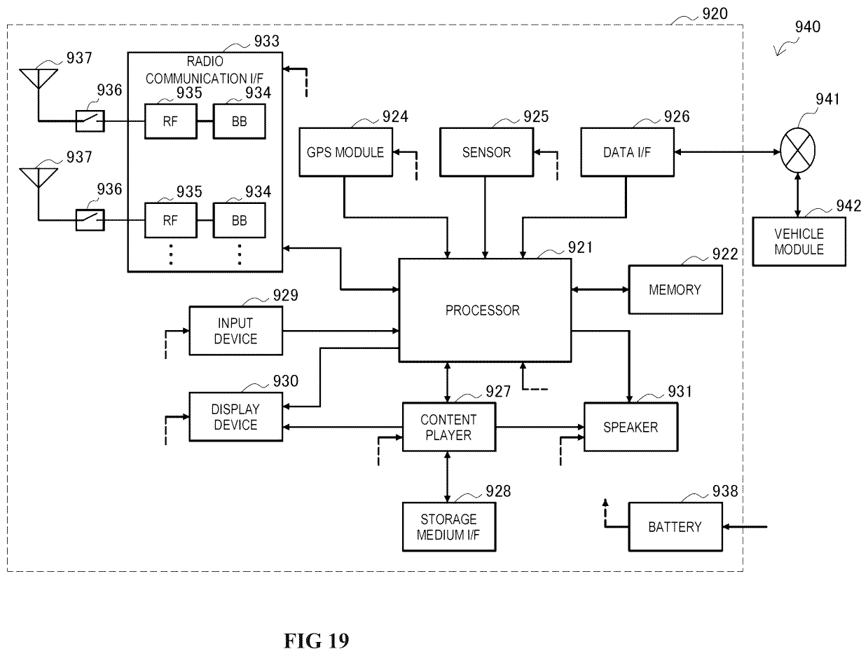

FIG. 19 is a block diagram illustrating an example of a schematic configuration of a car navigation device 920 to which an embodiment of the technology of the present application may be applied. The car navigation device 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example, a CPU or a SoC, and controls a navigation function and other functions of the car navigation device 920. The memory 922 includes RAM and ROM, and stores a program that is executed by the processor 921, and data.

The GPS module 924 uses GPS signals received from a GPS satellite to measure a position, such as latitude, longitude, and altitude, of the car navigation device 920. The sensor 925 may include a group of sensors such as a gyro sensor, a geomagnetic sensor, and an air pressure sensor. The data interface 926 is connected to, for example, an in-vehicle network 941 via a terminal that is not shown, and acquires data generated by the vehicle, such as vehicle speed data.

The content player 927 reproduces content stored in a storage medium, such as a CD and a DVD, that is inserted into the storage medium interface 928. The input device 929 includes, for example, a touch sensor configured to detect touch onto a screen of the display device 930, a button, or a switch, and receives an operation or an information input from a user. The display device 930 includes a screen such as a LCD or an OLED display, and displays an image of the navigation function or content that is reproduced. The speaker 931 outputs sounds of the navigation function or the content that is reproduced.

The radio communication interface 933 supports any cellular communication scheme, such as LTE, LTE-A or NR, and performs radio communication. The radio communication interface 933 may typically include, for example, a BB processor 934 and an RF circuit 935. The BB processor 934 may perform, for example, encoding/decoding, modulating/demodulating, and multiplexing/demultiplexing, and performs various types of signal processing for radio communication. Meanwhile, the RF circuit 935 may include, for example, a mixer, a filter, and an amplifier, and transmits and receives radio signals via the antenna 937. The radio communication interface 933 may be a one chip module which integrates the BB processor 934 and the RF circuit 935 thereon. The radio communication interface 933 may include multiple BB processors 934 and multiple RF circuits 935, as illustrated in FIG. 19. Although FIG. 19 illustrates the example in which the radio communication interface 933 includes multiple BB processors 934 and multiple RF circuits 935, the radio communication interface 933 may also include a single BB processor 934 or a single RF circuit 935.

Furthermore, in addition to a cellular communication scheme, the radio communication interface 933 may support another type of radio communication scheme such as a short-distance wireless communication scheme, a near field communication scheme, and a wireless LAN scheme. In that case, the radio communication interface 933 may include the BB processor 934 and the RF circuit 935 for each radio communication scheme.

Each of the antenna switches 936 switches connection destinations of the antennas 937 among multiple circuits (such as circuits for different radio communication schemes) included in the radio communication interface 933.

The antennas 937 may include multiple antenna elements, such as multiple antenna elements included in an MIMO antenna, and is used for the radio communication interface 933 to transmit and receive radio signals. The car navigation device 920 may include the multiple antennas 937, as illustrated in FIG. 19. Although FIG. 19 illustrates the example in which the car navigation device 920 includes multiple antennas 937, the car navigation device 920 may also include a single antenna 937.

Furthermore, the car navigation device 920 may include the antenna 937 for each radio communication scheme. In that case, the antenna switches 936 may be omitted from the configuration of the car navigation device 920.

The battery 938 supplies power to blocks of the car navigation device 920 illustrated in FIG. 19 via feeder lines that are partially shown as dashed lines in the figure. The battery 938 accumulates power supplied from the vehicle.

In the car navigation device 920 illustrated in FIG. 19, one or more of the components included in the processing circuitry may be implemented in the radio communication interface 933. Alternatively, at least a part of these components may also be implemented in the processor 921. As an example, the car navigation device 920 includes a part (for example, the BB processor 934) or the entire of the radio communication interface 933 and/or a module including the processor 921, and the one or more components may be implemented in the module. In this case, the module may store a program (in other words, a program causing the processor to execute operations of the one or more components) causing the processor to function as the one or more components, and execute the program. As another example, a program causing the processor to function as the one or more components may be installed in the car navigation device 920, and the radio communication interface 933 (for example, the BB processor 934) and/or the processor 921 may execute the program. As described above, as a device including the one or more components, the car navigation device 920 or the module may be provided. A program causing the processor to function as the one or more components may also be provided. In addition, a readable medium in which the program is recorded may be provided.

The technology of the present application may also be realized as an in-vehicle system (or a vehicle) 940 including one or more blocks of the car navigation device 920, the in-vehicle network 941, and a vehicle module 942. The vehicle module 942 generates vehicle data such as vehicle speed, engine speed, and malfunction information, and outputs the generated data to the in-vehicle network 941.

In addition, readable medium recording programs therein can be provided. Therefore, the present disclosure further relates to a computer readable storage medium, storing a program including instructions thereon, which are used to perform the communication method when loaded and executed by the processing circuitry.

Although the illustrative embodiments of the present disclosure have been described with reference to the accompanying drawings, the present disclosure is certainly not limited to the above examples. Those skilled in the art may achieve various adaptions and modifications within the scope of the appended claims, and it will be appreciated that these adaptions and modifications certainly fall into the scope of the technology of the present disclosure.

For example, in the above embodiments, the multiple functions included in one module may be implemented by separate means. Alternatively, in the above embodiments, the multiple functions included in multiple modules may be implemented by separate means, respectively. In additions, one of the above functions may be implemented by multiple modules. Needless to say, such configurations are included in the scope of the technology of the present disclosure.

In this specification, the steps described in the flowcharts include not only the processes performed sequentially in chronological order, but also the processes performed in parallel or separately but not necessarily performed in chronological order. Furthermore, even in the steps performed in chronological order, needless to say, the order may be changed appropriately.

Although the present disclosure and its advantages have been described in detail, it will be appreciated that various changes, replacements and transformations may be made without departing from the spirit and scope of the present disclosure as defined by the appended claims. In addition, the terms “include”, “comprise” or any other variants of the embodiments of the present disclosure are intended to be non-exclusive inclusion, such that the process, method, article or device including a series of elements includes not only these elements, but also those that are not listed specifically, or those that are inherent to the process, method, article or device. In case of further limitations, the element defiend by the sentence “include one” does not exclude the presence of additional same elements in the process, method, article or device including this element.

1. An electronic device for a network control device, comprising:
a processing circuitry configured to
interact with one or more neighbor cells of a user equipment (UE) to acquire support information on a network slice type suitable for the UE fed back by each of the neighbor cells;
based on the support information, evaluate a service capability metric for each of the neighbor cells with respect to said network slice type; and
at least based on the service capability metric, determine a selection priority of each of the neighbor cells for the UE.

2. The electronic device according to claim 1, wherein the processing circuitry is further configured to:
based on the evaluated service capability metric, determine RACH resources to be reserved by corresponding neighbor cell for said network slice type; and
inform the corresponding neighbor cell and the UE of the determined RACH resource reservation information.

3. The electronic device according to claim 1, wherein the interacting comprises one of
determining the network slice type suitable for the UE based on Service Level Agreement (SLA) parameters registered by the UE, and sending information on the network slice type to the one or more neighbor cells; or
sending the SLA parameters registered by the UE to the one or more neighbor cells.

4. The electronic device according to claim 3, wherein the interacting comprises:
receiving, from each of the one or more neighbor cells, support information on whether the neighbor cell supports said network slice type or not.
inquiring a neighbor cell which supports said network slice type about a current service load for said network slice type; and
receiving, from the neighbor cell, support information on the current service load for said network slice type.

5. (canceled)

6. The electronic device according to claim 3, wherein the interacting comprises:
receiving, from each of the one or more neighbor cells, support information on whether the neighbor cell supports said network slice type or not and on a current service load for said network slice type.

7. The electronic device according to claim 3, wherein the SLA parameters includes at least one of transmission latency, transmission rate, service priority, security, and reliability.

8. The electronic device according to claim 1, wherein said network slice type includes one of URLLC slice, eMBB slice, and mMTC slice.

9. The electronic device according to claim 1, wherein the processing circuitry is configured to initiate said interacting in occurrence of the following:
the UE moving to another tracking area;
quality of service of the network slice currently provided by a serving cell of the UE not meeting Service Level Agreement (SLA) parameters registered by the UE; or
per predetermined time interval.

10. The electronic device according to claim 4, wherein the processing circuitry is configured to evaluate the service capability metric η_{α} for each of the neighbor cells with respect to said network slice type according to
$${η}_{α} = tanh ( {S}_{{SLA}_{α}} \cdot ( 1 - \frac{{N}_{SLA \_α}}{{N}_{SLA \_α max}} ) ) \cdot {γ}_{α}$$
where S_{SLA}_{_{α}} is an average satisfaction of service of the network slice type a currently provided by the neighbor cell, N_{SLA_α} is a current service load for the network slice type α of the neighbor cell, N_{SLA_αmax} is an upper limit of service load for the network slice type α of the neighbor cell, and γ_{α} is a binary variable indicating whether the neighbor cell supports the network slice type α or not.

11. The electronic device according to claim 2, wherein the processing circuitry is configured to determine an amount Nr_{α} of the RACH resources that should be reserved by a neighbor cell:
Nr_{α}=tan h(N_{Σ})˜η_{α}˜λ
where N_{Σ} is a number of UEs that might select the network slice type α of the neighbor cell, η_{α} is the service capability metric for the neighbor cell with respect to the network slice type α, and λ is a selection frequency parameter.

12. The electronic device according to claim 2, wherein the processing circuitry is configured to reserve the RACH resources for the network slice type in idle RACH resources of the neighbor cell.

13. The electronic device according to claim 1, wherein the processing circuitry is further configured to:
send information on the selection priorities of the neighbor cells to the UE, so that the UE selects or reselects a cell to access based on the selection priorities.

14. The electronic device according to claim 1, wherein the processing circuitry is further configured to:
send information on the selection priorities of the neighbor cells to a serving cell of the UE, so that the serving cell selects a target cell to be switched to based on the selection priorities.

15. An electronic device for a user equipment (UE), comprising:
a processing circuitry configured to
receive information on selection priorities of one or more neighbor cells, wherein the selection priorities are determined by a network control device based on a service capability metric for each of the neighbor cells with respect to a network slice type suitable for the UE; and
based on the selection priorities, select a neighbor cell to access.

16. The electronic device according to claim 15, wherein the processing circuitry is further configured to:
receive information on RACH resources to be reserved by a particular neighbor cell for the network slice type, the reserved RACH resources are determined by the network control device based on the service capability metric for the particular neighbor cell; and
access the particular neighbor cell on the reserved RACH resources.

17. (canceled)

18. An electronic device for a cell, comprising:
a processing circuitry configured to
feed back support information on a particular network slice type to a network control device, for the network control device to determine a service capability metric for the cell with respect to the particular network slice type;
receive RACH resource reservation information for the particular network slice type determined by the network control device based on the service capability metric; and
reserve RACH resources determined for the particular network slice type based on the RACH resource reservation information.

19.-20. (canceled)
